(19) United States
(12) Patent Application Publication
(10) Pub. No.: US 2013/0291698 A1
(43) Pub. Date: Nov. 7, 2013

(54) CUTTING KNIFE WITH DEFLECTOR

(71) Applicant: Weber Maschinenbau GmbH Breidenbach, (US)

(72) Inventor: Oliver Lotz, Biedenkopf (DE)

(21) Appl. No.: 13/861,927

(22) Filed: Apr. 12, 2013

(30) Foreign Application Priority Data
Apr. 12, 2012 (DE) 10 2012 007 290.2

(51) Int. Cl. B26D 7/06

(52) U.S. Cl. CPC B26D 7/065
USPC 83/105

(57) ABSTRACT

The cutting knife, especially when used for high-speed slicers, serves to slice food products, in particular fresh meat or cheese. In the blade area it has, on the outer side thereof, at least one deflector, which is configured as a shaped piece formed towards the outside and substantially following the cutting edge. The cutting knife may be configured as a circular knife or a sickle knife.

### CROSS-REFERENCE TO RELATED APPLICATIONS

This application claims priority to German Patent Application 10 2012 007 290.2 filed on Apr. 12, 2012, which is hereby incorporated by reference in its entirety.

### TECHNICAL FIELD

The present disclosure relates to a drivable cutting knife for machines for slicing food products, in particular cheese and fresh meat, the blade area of the knife having associated therewith a deflector for a slice of food on the knife side facing the cut-off slice.

### BACKGROUND

DE 637 833 discloses this kind of knife for a machine for slicing food products. The knife has associated therewith, in a displaceable or easily releasable manner, a push plate as a deflector. The push plate may be configured as an element having a semicircular cross-section, said element being pivotably supported in a groove, which is semicircular as well, such that it either follows the contour of the blade or projects beyond the latter.

According to another embodiment, the push plate is configured as an element having a rectangular cross-section, which is adapted to be moved on the knife away from the cutting edge or which is arranged in an easily releasable manner. Both embodiments are intended to prevent cheese foodstuffs from sticking to the knife.

This known solution may be acceptable for manually operated slicers, but this does not apply to high-speed slicers. The risk that the product to be cut may be injured when it hits the deflector is too high. Moreover, if the speeds used are comparatively high, the deflectors may change position during rotation.

DE 10 2009 006 912 discloses a circular cutting knife provided with spherical projections in the blade area. During slicing, these spherical projections serve to reduce the friction between the knife surface and the slices of the respective product, whereby the slices are accelerated to a lesser extent through the rotation of the cutting knife. This is intended to allow exact laying down of the respective slices.

Another cutting knife is known from DE 10 2007 040 350, said cutting knife being configured as a sickle knife. It serves to slice food products, in particular cheese. For the quality of the cutting operation, the so-called cutting edge angle a has to be taken into account. It is located on the radially outer circumference of the cutting knife. As regards a more precise definition of this angle, the disclosure of DE 10 2007 040 350 is explicitly referred to.

If the cutting edge angle a is too large, the product, i.e. the slice of food, may have applied thereto an excessively high pressure and may be compressed.

If the pressure applied is not high enough, the slice of food may be deflected insufficiently during the cutting operation, i.e. the desired lay-down characteristics are not accomplished.

It is therefore the object of the present disclosure to provide, especially for high-speed slicers, a cutting knife of the type specified at the beginning, which, primarily at high cutting speeds, causes a well-directed laying down of the product to be cut and which simultaneously optimizes the aerodynamics of the cutting knife.

### SUMMARY

According to the present disclosure, this object is achieved in that at least one deflector defines a shaped piece formed towards the outside and substantially following the cutting edge of the cutting knife, which is configured as a circular knife or a sickle knife.

According to the disclosure, the deflector represents an integral component of the knife. The latter may be configured as a circular knife or as a sickle knife. The deflector substantially follows the geometry of the cutting edge and is provided on the outer side of the knife, i.e. it is located on the knife side associated with the cut-off slice of food.

The deflector has, among other functions, the function of an air guide surface in the sense of a spoiler. Since the knife normally rotates at a high rotary speed, a radial flow of air occurs on the radially inner side of the shaped piece in the border area to the surface of the knife, and an air cushion is formed on the radially outer side in the gap between the knife and the slice to be cut off, said air flow and said air cushion providing together a soft, substantially contact-free deflection of the product to be cut, in the vicinity of the shaped piece.

This effect is primarily produced by high rotary speeds, which are given in the case of high-speed slicers. Such indirect deflection is advantageous, since the risk that the product to be cut may be injured by the deflector is prevented or reduced.

In addition, the cutting knife and the deflector, respectively, will get less dirty through the cutting operation.

In this context, it will be of advantage when the cutting edge angle a of the knife is not too large. As has already been mentioned hereinbefore, a comparatively acute cutting edge angle a will cause little pressure when the product is being cut. Especially in the case of soft products, such as fresh meat, cheese and also Leberkase (loaf of baked sausage meat), this has the advantage that the product will undergo little deformation and, in view of the comparatively small contact surface, stick less to the knife. The above-mentioned air cushion contributes to this effect, said air cushion being formed due to aerodynamics in front of the shaped piece in the gap of the product to be cut and directing the slice to be cut off smoothly to the lay-down side.

According to an advantageous further development of the disclosure, the shaped piece may be triangular in cross-section. This kind of cross-section increases the stability of the knife and ensures an advantageous deflection during the cutting operation.

The shaped piece may here be slightly flattened at the apex of the triangular shape, so as to avoid physical contact with the slice to be cut off and so as to direct the flow of air advantageously onto the back of the slice to be cut off. Furthermore, it is imaginable to arrange two or more deflectors equidistantly with respect to the cutting edge. These deflectors may be used in common for configuring the deflection flow. It is here also possible to vary the distance between the deflectors along the circumference. The deflectors may also be convex in cross-section and variable in height in the circumferential direction. In particular, it is imaginable that they increase in height in the circumferential direction.

The deflectors facing away from the cutting edge may here also be higher.

### BRIEF DESCRIPTION OF THE DRAWINGS

In the following, the disclosure will be described making reference to a drawing, in which:

FIG. 1 shows a top view of a sickle knife according to the present disclosure,

FIG. 2 shows a vertical section through the knife according to FIG. 1 along line II-II,

FIG. 3 shows a top view of another embodiment of a sickle knife, which is provided with embossed shaped pieces in a spacing area, and

FIG. 4 shows a vertical section through the sickle knife of FIG. 3 along line IV-IV.

### DETAILED DESCRIPTION

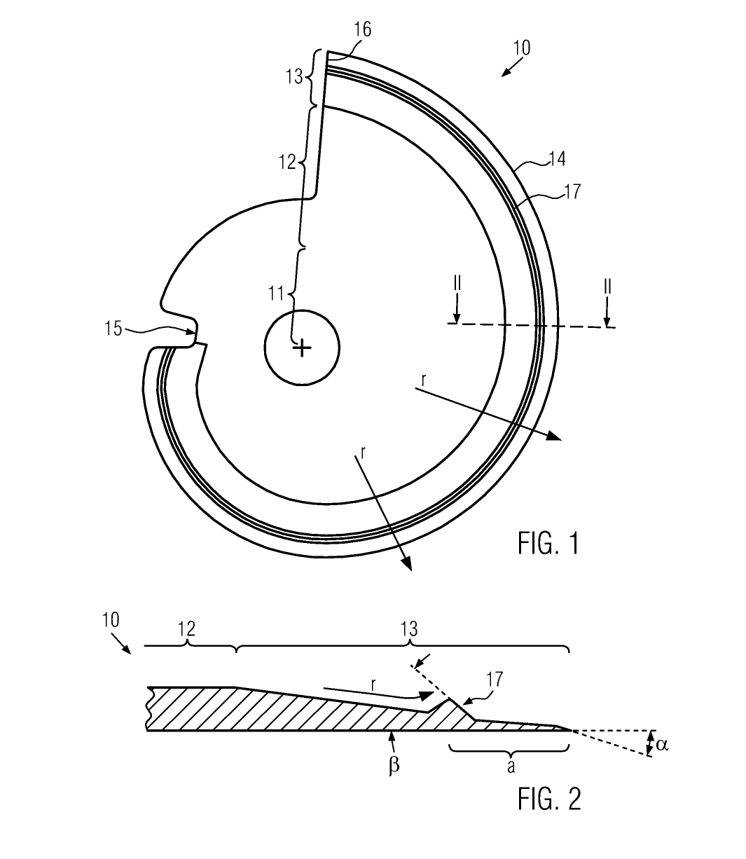

The cutting knife 10 shown in FIG. 1 is provided for machines for slicing food products, in particular fresh meat or cheese, said machines being not shown. It may especially be used in high-speed slicers. It is provided with a mounting area 11 with which the cutting knife can be fixed to a drive shaft, which is not shown, on one side thereof. The mounting area 11 is followed by a spacing area 12 in a radially outward direction, said spacing area 12 being, in turn, supplemented by a blade area 13.

The sickle knife shown corresponds, by the way, to that disclosed in DE 10 2007 040 350, which was filed by the same applicant. The disclosure of this reference is explicitly referred to.

The cutting knife 10 has a cutting edge 14 deviating from a circular shape and extending in the form of a spiral. The cutting edge 14 starts at an indentation 15 and terminates at a radial end edge 16. The blade has a cutting edge angle a, which is responsible for the cut. In the present case this angle is chosen comparatively small.

FIG. 1 shows the knife 10 with the outer side thereof, i.e. with the surface associated with a cut-off slice of food. On this side, the knife is provided with at least one deflector 17. The latter is defined by a shaped piece formed towards the outside and formed integrally with the cutting knife, as can e.g. be seen in FIG. 2. The deflector 17 may follow the cutting edge 14 in uniformly spaced relationship a therewith, as is exemplarily shown in FIGS. 1 and 2.

From FIG. 2 it can be seen that, in the present case, the deflector 17 is triangular in cross-section and defines a protuberance with flanks of approximately equal length. In the present case, an angle of approx. 100° is formed between these flanks.

The front flank defines a flank angle β of approx. 45° with the lower side of the knife. Both the cutting edge angle a and the flank angle β influence the aerodynamics between the knife and the product to be cut, i.e. the slice to be cut off, when the cutting knife rotates during the cutting operation.

On the one hand, a radial flow r is obtained in the border area between knife and air due to the high rotary speed of the knife, said radial flow r being directed outwards from the center of the knife and deflected upwards on the back of the deflector 17.

On the other hand, an air cushion 19 is formed between the cutting edge 14 and the outer flank of the deflector 17 due to the penetration of the knife into the product to be cut, said air cushion 19, together with the radial air flow r, having the effect that the slice to be cut off is bent and deflected away from the knife softly and smoothly. The deflector functions here as an air guide surface in the sense of a spoiler onto which the radial air flow r is directed on the inner flank thereof and the air cushion 19 on the outer flank thereof.

The deflector 17 may vary in height in the circumferential direction. It may increase in height towards the end edge 16.

The cutting knife 10 may also be configured as a circular knife, the above explanations applying in this case analogously.

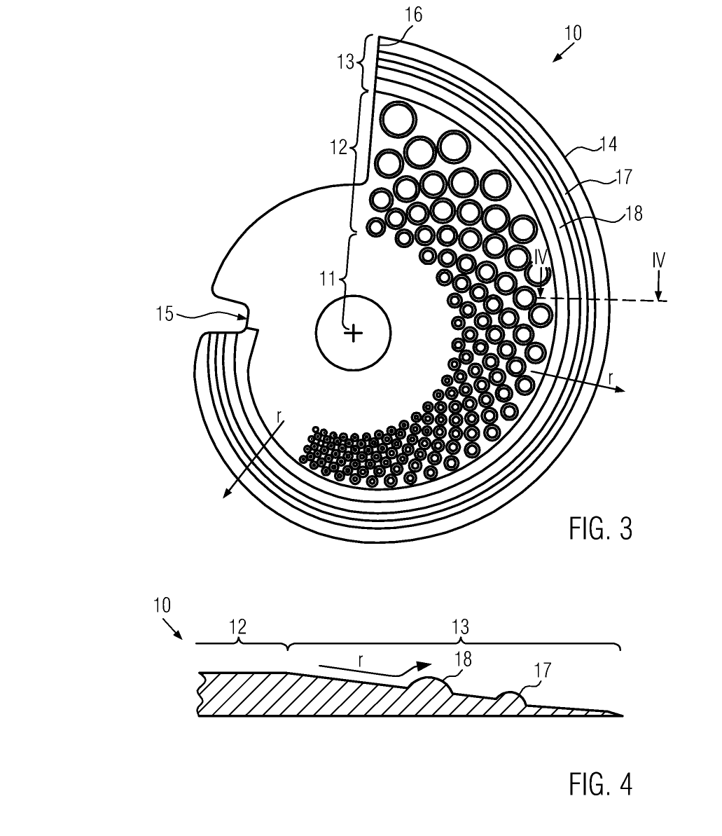

FIG. 3 shows a further embodiment of a cutting knife configured as a sickle knife, and the side shown is again the outer side. In order to avoid repetitions, corresponding parts are provided with identical reference numerals. Only the differences will be discussed hereinbelow.

The spacing area 12 of this embodiment is provided with embossed alternately recessed and raised shaped pieces 20, which serve to reinforce the cutting knife. They may be circular in shape or define elongate recesses oriented primarily in a radial direction. They may extend one behind the other in a radial direction, and their radially outer end may be broader than the radially inner end thereof. In addition, the shaped pieces may increase in depth in a radial direction.

Primarily radially directed shaped pieces may, together with deflectors 17 and 18, produce a radial flow of air during the cutting operation, said radial flow of air allowing an appropriate deflection of the product to be cut from the knife, without damage being caused to the knife at high cutting speeds.

An additional deflector 18, which is displaced radially inwards, extends parallel to the outer deflector 17, said deflector 18 being slightly broader than the deflector 17, as can be seen in FIG. 4.

Both deflectors 17 and 18 are convex in shape, and the element 18 is higher than the element 17. In the present case, they both follow the cutting edge 14 equidistantly, but it is also imaginable to vary, e.g. increase, the distance to the cutting edge along the circumference.

The cutting knives 10 may have a small cutting edge angle a so as to keep the cutting pressure low. With the aid of an air cushion 19 between the knife and the slice, the deflectors 17, 18 nevertheless guarantee that the product to be cut will be laid down adequately. This is of advantage, in particular in the case of sticky products such as cheese, but also in the case of fresh meat.

1. A rotatably drivable cutting knife for machines for slicing food products, comprising:
at least one knife with a blade area, the blade area of the knife having associated therewith a deflector for a slice of food on the knife side facing the cut-off slice, wherein at least one deflector defines a shaped piece formed towards the outside and following the cutting edge of the cutting knife, which is configured as a circular knife or a sickle knife.

2. A cutting knife according to claim 1, wherein the deflector is triangular in cross-section.

3. A cutting knife according to claim 1, wherein the shaped piece is flattened at the apex of the triangular shape.

4. A cutting knife according to claim 1, wherein two or more deflectors follow the cutting edge equidistantly.

5. A cutting knife according to claim 1, wherein the deflectors have flanks with different angles of inclination, in particular the radially inner flanks having a smaller angle of inclination than the radially outer ones.

6. A cutting knife according to claim 1, wherein the deflectors are convex in shape.

7. A cutting knife according to claim 1, wherein the deflectors may be variable in height.

8. A cutting knife according to at least one of the preceding claim 1, wherein the deflectors increase in height in the circumferential direction.

9. A cutting knife according to claim 1, wherein the height of the radially inner deflectors exceeds that of the radially outer ones.

10. A cutting knife according to claim 2, wherein the radially inner flank of the deflector has a smaller angle of inclination than the radially outer flank thereof.

11. A cutting knife according to claim 1, wherein the cutting knife has a comparatively small cutting edge angle (α).
